(19) United States
(12) Patent Application Publication
(10) Pub. No.: US 2021/0241105 A1
(43) Pub. Date: Aug. 5, 2021

(54) INFERENCE APPARATUS, INFERENCE METHOD, AND STORAGE MEDIUM

(71) Applicant: CANON KABUSHIKI KAISHA, Tokyo (JP)

(72) Inventor: Nobuyuki Horie, Tokyo (JP)

(21) Appl. No.: 17/161,207

(22) Filed: Jan. 28, 2021

(30) Foreign Application Priority Data
Feb. 3, 2020 (JP) 2020-016491

(51) Int. Cl. G06N 3/08; G06N 3/04

(52) U.S. Cl. CPC G06N 3/08; G06N 3/0454

(57) ABSTRACT

There is provided an inference apparatus that shares inference processing with an external inference apparatus. The inference processing uses a first neural network having an input layer, a plurality of intermediate layers, and an output layer. A control unit performs control for performing computational processing of a first part of the first neural network with respect to input data input to the input layer. The first part of the first neural network is a part from the input layer to a specific intermediate layer that, of the plurality of intermediate layers, has a lower number of nodes than the input layer. A sending unit sends output data from the specific intermediate layer to the external inference apparatus. A receiving unit receives a first inference result from the external inference apparatus.

### BACKGROUND OF THE INVENTION

### Field of the Invention

The present invention relates to an inference apparatus, an inference method, and a storage medium.

### Description of the Related Art

Conventionally, inference processing apparatuses that make inferences using neural networks have been known. What are known as convolutional neural networks (CNNs) are often used especially in inference processing apparatuses which perform image recognition.

With a convolutional neural network, a final inference result, in which a target object contained in an image is recognized, is obtained by subjecting input image data to intermediate layer processing and fully-connected layer processing in sequence. In the intermediate layers, a plurality of feature amount extraction processing layers are hierarchically connected, and in each processing layer, convolution operation processing, activation processing, and pooling processing are performed on the input data input from the previous layer. The intermediate layers extract a feature amount contained in the input image data in higher dimensions by repeating the processing in each processing layer in this manner. In the fully-connected layer, the computational result data from the intermediate layer is combined to obtain the final inference result. To extract feature amounts in higher dimensions, the number of intermediate layers is essential in terms of the accuracy of the final inference result.

However, when the number of intermediate layers is increased, the inference processing by the neural network involves a much greater computational load, which leads to an increase in processing time in apparatuses which have relatively low computational processing power, such as image capturing apparatuses. Accordingly, one conceivable way to solve this problem is to transmit input images to a server that has relatively high computational processing power and perform the neural network inference in the server.

For example, International Publication No. 2018/011842 discloses a technique in which when neural network learning is to be performed in a server, some intermediate layer processing is performed in an image capturing apparatus before transmitting private information to the server in order to ensure the confidentiality of the information.

However, when performing inference processing using the technique disclosed in International Publication No. 2018/011842, communication may take a long time depending on the size of the data to be sent from the image capturing apparatus to the server. As such, even if the time required for computational processing is shortened, the time taken before the final inference result is actually obtained may not be shortened significantly.

### SUMMARY OF THE INVENTION

Having been conceived in light of such circumstances, the present invention provides a technique for sharing inference processing between two inference apparatuses so as to shorten the time required for communication between the two inference apparatuses.

According to a first aspect of the present invention, there is provided an inference apparatus that shares inference processing with an external inference apparatus, the inference processing using a first neural network having an input layer, a plurality of intermediate layers, and an output layer, and the inference apparatus comprising: a control unit configured to perform control for performing computational processing of a first part of the first neural network with respect to input data input to the input layer, the first part of the first neural network being a part from the input layer to a specific intermediate layer that, of the plurality of intermediate layers, has a lower number of nodes than the input layer; a sending unit configured to send output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and a receiving unit configured to receive the first inference result from the external inference apparatus.

According to a second aspect of the present invention, there is provided an inference apparatus that shares inference processing with an external inference apparatus, the inference processing using a first neural network having an input layer, a plurality of intermediate layers, and an output layer, and the inference apparatus comprising: a receiving unit configured to receive, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer; a control unit configured to perform control for obtaining a first inference result by performing computational processing of a second part of the first neural network with respect to the output data from the specific intermediate layer, the second part of the first neural network being a remaining part excluding the first part from the first neural network; and a sending unit configured to send the first inference result to the external inference apparatus.

According to a third aspect of the present invention, there is provided an inference method, executed by an inference apparatus, for sharing inference processing with an external inference apparatus, the inference processing using a first neural network having an input layer, a plurality of intermediate layers, and an output layer, and the inference method comprising: performing control for performing computational processing of a first part of the first neural network with respect to input data input to the input layer, the first part of the first neural network being a part from the input layer to a specific intermediate layer that, of the plurality of intermediate layers, has a lower number of nodes than the input layer; sending output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and receiving the first inference result from the external inference apparatus.

According to a fourth aspect of the present invention, there is provided an inference method, executed by an inference apparatus, for sharing inference processing with an external inference apparatus, the inference processing using a first neural network having an input layer, a plurality of intermediate layers, and an output layer, and the inference method comprising: receiving, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer; performing control for obtaining a first inference result by performing computational processing of a second part of the first neural network with respect to the output data from the specific intermediate layer, the second part of the first neural network being a remaining part excluding the first part from the first neural network; and sending the first inference result to the external inference apparatus.

According to a fifth aspect of the present invention, there is provided a non-transitory computer-readable storage medium which stores a program for causing a computer to execute an inference method for sharing inference processing with an external inference apparatus, the inference processing using a first neural network having an input layer, a plurality of intermediate layers, and an output layer, and the inference method comprising: performing control for performing computational processing of a first part of the first neural network with respect to input data input to the input layer, the first part of the first neural network being a part from the input layer to a specific intermediate layer that, of the plurality of intermediate layers, has a lower number of nodes than the input layer; sending output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and receiving the first inference result from the external inference apparatus.

According to a sixth aspect of the present invention, there is provided a non-transitory computer-readable storage medium which stores a program for causing a computer to execute an inference method for sharing inference processing with an external inference apparatus, the inference processing using a first neural network having an input layer, a plurality of intermediate layers, and an output layer, and the inference method comprising: receiving, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer; performing control for obtaining a first inference result by performing computational processing of a second part of the first neural network with respect to the output data from the specific intermediate layer, the second part of the first neural network being a remaining part excluding the first part from the first neural network; and sending the first inference result to the external inference apparatus.

Further features of the present invention will become apparent from the following description of exemplary embodiments with reference to the attached drawings.

### BRIEF DESCRIPTION OF THE DRAWINGS

FIG. 1 is a diagram illustrating an example of the overall configuration of an inference system 100 using a neural network.

FIG. 2 is a diagram illustrating an example of the hardware configuration of the inference system 100.

FIG. 3 is a conceptual diagram illustrating the sharing of inference processing.

FIG. 4 is a conceptual diagram illustrating a training phase according to a first embodiment.

FIG. 5 is a flowchart illustrating inference processing according to the first embodiment.

FIG. 6 is a conceptual diagram illustrating another example of a training phase according to the first embodiment.

FIG. 7A is a conceptual diagram illustrating a training phase according to a second embodiment.

FIG. 7B is a conceptual diagram illustrating another example of a training phase according to the second embodiment.

FIG. 8 is a flowchart illustrating inference processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

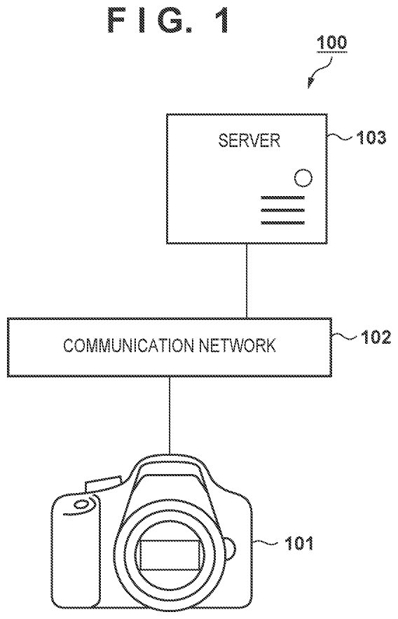

FIG. 1 is a diagram illustrating an example of the overall configuration of an inference system 100 using a neural network. The inference system 100 executes computations in which an input layer, a plurality of intermediate layers that extract feature amounts contained in data input from previous layers, and an output layer are connected hierarchically. As illustrated in FIG. 1, the inference system 100 includes an image capturing apparatus 101 (e.g., a digital camera), a server 103, and a communication network 102 (e.g., the Internet). The image capturing apparatus 101 and the server 103 communicate various types of information over the communication network 102.

Note that in the present embodiment, the image capturing apparatus 101 and the server 103 are merely examples of two inference apparatuses that share inference processing. For example, a mobile phone, a tablet terminal, or the like may be used instead of the image capturing apparatus 101 as the inference apparatus requesting the sharing. When the computational processing power of the server 103, which is the inference apparatus with which the processing is shared, is greater than the computational processing power of the image capturing apparatus 101, which is the inference apparatus requesting the sharing, the time required for the inference processing is shortened (although this does depend on the communication speed). Here, “computational processing power” refers to capabilities with respect to how fast neural network inference (matrix operations and the like) can be processed. However, the relative levels of the computational processing powers of the two inference apparatuses are not particularly limited. Even if the computational processing power of the server 103 is lower than the computational processing power of the image capturing apparatus 101, sharing the inference processing can provide some effects, such as reducing the amount of power consumed by the image capturing apparatus 101, for example.

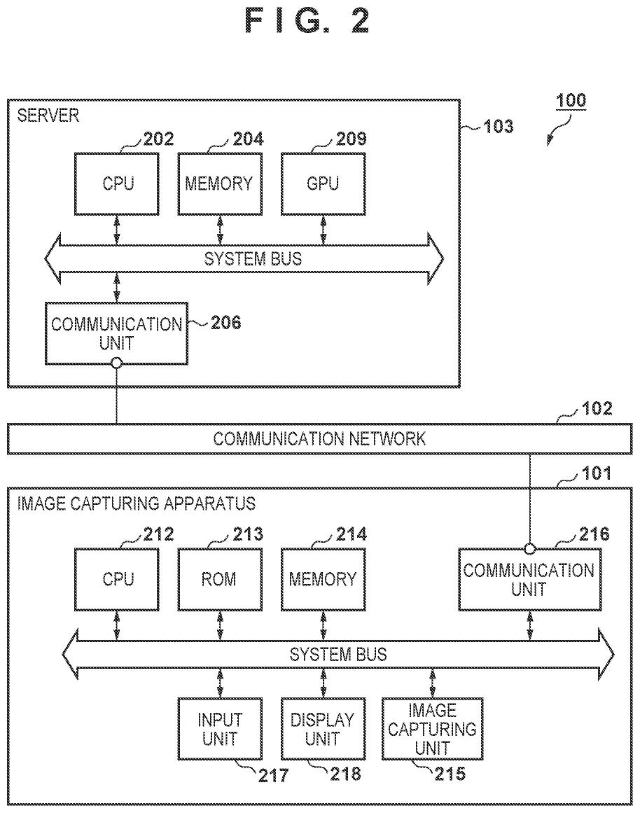

FIG. 2 is a diagram illustrating an example of the hardware configuration of the inference system 100. As illustrated in FIG. 2, the image capturing apparatus 101 and the server 103 are connected to each other over the communication network 102.

The image capturing apparatus 101 includes a system bus 211, and a CPU 212, ROM 213, memory 214, an image capturing unit 215, a communication unit 216, an input unit 217, and a display unit 218 are connected to each other by the system bus 211. The various units connected to the system bus 211 are configured to be capable of exchanging data with one another via the system bus 211.

The ROM 213 stores various types of programs and the like for the CPU 212 to operate. Note that the various types of programs for the CPU 212 to operate are not limited to being stored in the ROM 213, and may be stored in a hard disk or the like, for example.

The memory 214 is constituted by RAM, for example. The CPU 212 uses the memory 214 as work memory when executing the programs stored in the ROM 213.

The input unit 217 accepts user operations, generates control signals based on those operations, and supplies the control signals to the CPU 212. For example, the input unit 217 includes physical operation buttons, a touch panel, and the like as input devices that accept user operations. Note that the “touch panel” mentioned here refers to an input device configured to output coordinate information based on locations on an input unit, configured as a flat surface, that has been touched.

The CPU 212 controls the display unit 218, the image capturing unit 215, and the communication unit 216 in accordance with programs, on the basis of control signals supplied in response to user operations made through the input unit 217. Through this, the display unit 218, the image capturing unit 215, and the communication unit 216 can be caused to operate in accordance with the user operations.

The display unit 218 is, for example, a display, and includes a mechanism for outputting display signals for causing images to be displayed in the display. Note that when a touch panel is used as the input unit 217, the input unit 217 and the display can be configured as a single entity. For example, the touch panel is configured having a light transmittance that does not interfere with the displays made in the display, and is attached to an upper layer of a display surface of the display. By associating input coordinates in the touch panel with display coordinates of the display, the touch panel and the display can be configured as an integrated entity.

The image capturing unit 215 includes a shutter having lens and aperture functionality, an image sensor constituted by a CCD, a CMOS element, or the like that converts an optical image into electrical signals, an image processing unit that performs various types of image processing for exposure control, rangefinding control, and the like on the basis of the signals from the image sensor, and the like, and is a mechanism that performs a series of shooting processes. Shooting based on user operations made through the input unit 217 is also possible, under the control of the CPU 212.

The communication unit 216 communicates with the server 103 (an external inference apparatus) over the communication network 102, which is a LAN, the Internet, or the like, under the control of the CPU 212.

The server 103 includes a system bus 201, and a CPU 202, memory 204, a communication unit 206, and a GPU 209 are connected to the system bus 201. The various units connected to the system bus 201 are configured to be capable of exchanging data with one another via the system bus 201.

The memory 204 is constituted by RAM, for example, and is used as work memory for the CPU 202 and the GPU 209. The programs for the CPU 212 to operate are stored in a hard disk, ROM, or the like (not shown).

The communication unit 206 communicates with the image capturing apparatus 101 (an external inference apparatus) over the communication network 102, which is a LAN, the Internet, or the like, under the control of the CPU 202. In the present embodiment, the CPU 202 of the server 103 receives a communication request from the image capturing apparatus 101, generates a control signal based on the communication request, and causes the GPU 209 to operate. The communication between the image capturing apparatus 101 and the server 103 will be described in detail later.

The GPU (an acronym for Graphics Processing Unit) 209 is a processor which is capable of performing specialized processing for computer graphics operations. Furthermore, the GPU 209 is typically capable of performing computations required by neural networks, such as matrix operations, in a shorter amount of time than the CPU 202. Although the present embodiment assumes that the server 103 includes the CPU 202 and the GPU 209, the configuration is not limited thereto. Additionally, it is not necessary for only a single GPU 209 to be provided, and the server 103 may instead include multiple GPUs.

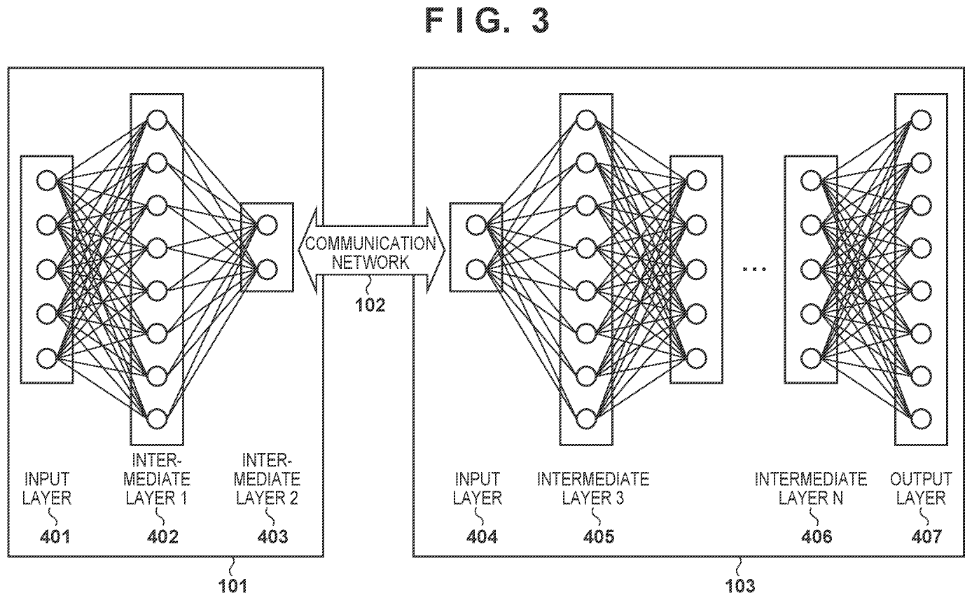

FIG. 3 is a conceptual diagram illustrating the sharing of inference processing. In the present embodiment, the processing of an input layer 401, an intermediate layer 1-402, and an intermediate layer 2-403 is executed in the image capturing apparatus 101. This processing is implemented by the CPU 212 of the image capturing apparatus 101 executing a program.

The image capturing apparatus 101 inputs the data from the intermediate layer 2-403 into an input layer 404 of the server 103 over the communication network 102. The server 103 executes the processing of the input layer 404, intermediate layer processing of an intermediate layer 3-405 to an intermediate layer N-406, and the processing of an output layer 407. This processing is implemented by the CPU 202 and the GPU 209 of the server 103 executing a program.

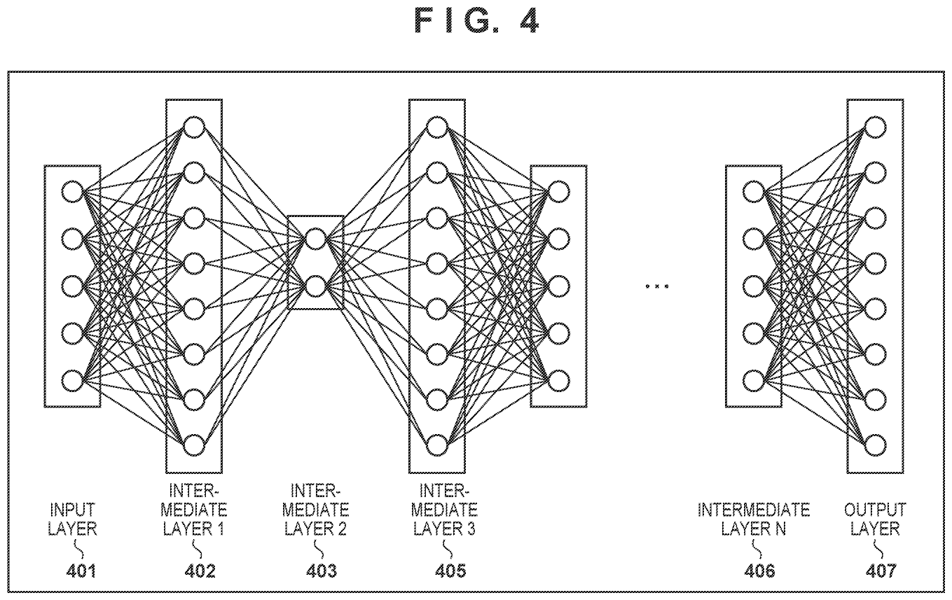

In the present embodiment, when training the neural network, a specific intermediate layer in which the data amount is low (the intermediate layer 2-403, in the example of FIG. 3) is intentionally prepared among the plurality of intermediate layers. Then, during inference, the image capturing apparatus 101 performs the processing up until the intermediate layer 2-403, and causes the server 103 to perform the remaining processing. The training for creating this kind of inference model will be described in detail with reference to FIG. 4.

FIG. 4 is a conceptual diagram illustrating a training phase according to the first embodiment. The present embodiment assumes that the training is performed in advance by a high-performance PC or the like. As illustrated in FIG. 4, in the present embodiment, a specific intermediate layer having a small number of nodes (the intermediate layer 2-403, in the example of FIG. 4) is intentionally created during the training. In the following descriptions, the intermediate layer intentionally created with a small number of nodes will be called a “low-node intermediate layer”. The low-node intermediate layer is an intermediate layer having a lower number of nodes than the input layer, and is, for example, the intermediate layer having the lowest number of nodes among the plurality of intermediate layers in the neural network.

In the example illustrated in FIG. 4, the position of the low-node intermediate layer is the position of the second intermediate layer (the intermediate layer 2-403). However, the position of the low-node intermediate layer is not particularly limited, and can be determined as desired on the basis of the computational processing power of the CPU 212 of the image capturing apparatus 101 so that the inference processing is completed within a predetermined amount of time, for example (assuming, however, that the inference accuracy is also taken into account, as described later).

By building an inference model and training the neural network in this manner, the data amount output from the intermediate layer 2-403 can be reduced. The position of and number of nodes in the low-node intermediate layer may be determined so as to suppress a drop in inference accuracy. For example, the inference accuracies of an inference model trained without creating a low-node intermediate layer and an inference model having a low-node intermediate layer can be compared in advance, and the position of and number of nodes in the low-node intermediate layer can be determined so that a drop in the accuracy is less than or equal to a threshold.

The inference processing can be shared by dividing an inference model trained according to the configuration in FIG. 4 at the position of the low-node intermediate layer (the intermediate layer 2-403) indicated in FIG. 3, and then passing the result from the intermediate layer 2-403 from the image capturing apparatus 101 to the server 103. Employing such a configuration makes it possible to implement an inference system capable of highly-accurate inference across multiple layers while suppressing an amount of communication in the communication network 102.

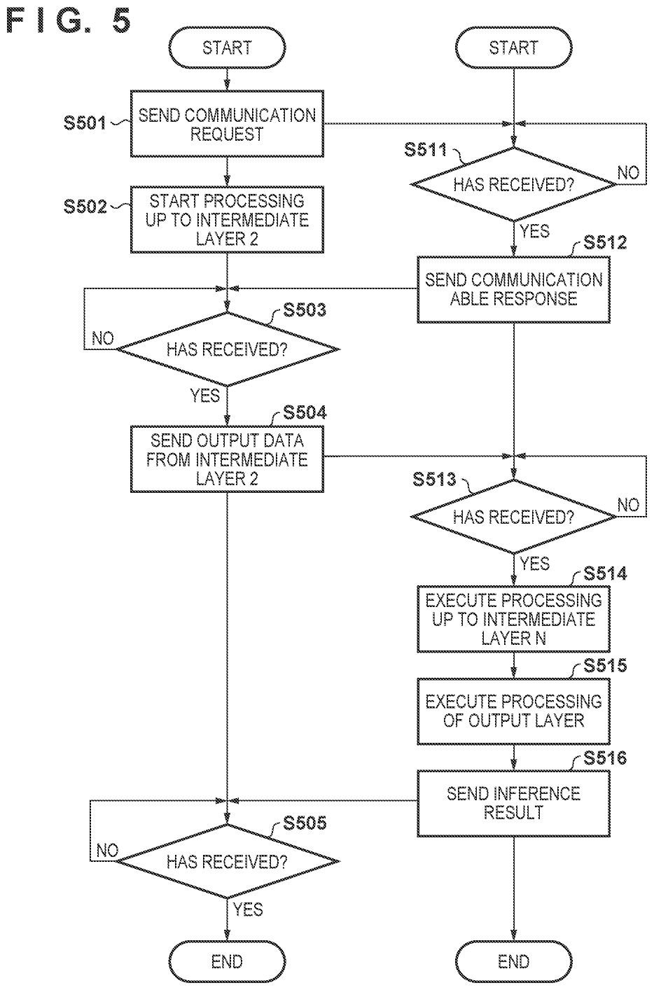

FIG. 5 is a flowchart illustrating inference processing according to the first embodiment. In FIG. 5, steps S501 to S505 are processing steps executed by the image capturing apparatus 101, whereas steps S511 to S516 are processing steps executed by the server 103.

The processing executed by the image capturing apparatus 101 will be described first. In step S501, the CPU 212 of the image capturing apparatus 101 sends a communication request to the server 103 through the communication unit 216. In step S502, the CPU 212 of the image capturing apparatus 101 starts the computational processing of the neural network, from the input layer 401 to the intermediate layer 2-403 indicated in FIG. 3, on an image shot by the image capturing unit 215. In other words, the image capturing apparatus 101 handles the computational processing of the part of the neural network from the input layer 401 to the intermediate layer 2-403 (the specific intermediate layer) (this part of the neural network will be called a “first part” of the neural network). This computational processing can be performed in parallel with the processing of the following step S503.

Note that the input data input to the input layer 401 (i.e., inference target data) is not limited to image data. Any data can be used as input data as long as the data is in a format which can be subject to the inference processing using the neural network.

In step S503, the CPU 212 of the image capturing apparatus 101 stands by to receive a communication able response from the server 103. Upon receiving the communication able response, the CPU 212 of the image capturing apparatus 101 determines that communication with the server 103 is possible, and the sequence moves to step S503. Although FIG. 5 indicates continuing to stand by until the communication able response is received, exception processing is actually necessary in the event that communication is not established. For example, if the communication able response is not received even after waiting a set amount of time, the CPU 212 of the image capturing apparatus 101 resends the communication request. Any publicly known method can be used with respect to establishing communication.

In step S504, the CPU 212 of the image capturing apparatus 101 sends output data from the intermediate layer 2-403 indicated in FIG. 3 to the server 103 through the communication unit 216. As described earlier, the intermediate layer 2-403 is prepared as a layer having an intentionally lower data amount at the time of training.

In step S505, the CPU 212 of the image capturing apparatus 101 stands by until an inference result (e.g., an image classification result) based on the output data from the output layer 407 is received from the server 103. Once the inference result is received, the processing of the image capturing apparatus 101 in this flowchart ends.

Then, the CPU 212 of the image capturing apparatus 101 can use the inference result with any method. For example, the CPU 212 of the image capturing apparatus 101 may control focus settings of the image capturing unit 215 on the basis of the inference result, or may add the inference result to a shot image as a tag.

The processing executed by the server 103 will be described next. In step S511, the CPU 202 of the server 103 stands by until the communication request is received from the image capturing apparatus 101. When the CPU 202 of the server 103 receives the communication request, the sequence moves to step S512. In step S512, the CPU 202 of the server 103 sends the communication able response to the image capturing apparatus 101.

In step S513, the CPU 202 of the server 103 stands by until the output data from the intermediate layer 2-403 is received from the image capturing apparatus 101. When the CPU 202 of the server 103 receives the output data, the sequence moves to step S514.

In step S514, the GPU 209 of the server 103 executes the computational processing of the neural network, from the intermediate layer N-406, using the output data from the intermediate layer 2-403 as the input data input to the input layer 404, in accordance with commands from the CPU 202. In other words, the server 103 handles the computational processing of the remaining part of the neural network excluding the part handled by the image capturing apparatus 101 (the first part of the neural network) (this remaining part will be called a “second part” of the neural network).

In step S515, the GPU 209 of the server 103 executes the computational processing of the neural network for the output layer 407. As a result, the inference processing on the shot image is completed, and an inference result (e.g., an image classification result) is obtained. In step S516, the CPU 202 of the server 103 sends the inference result to the image capturing apparatus 101 through the communication unit 206.

Sharing of the inference processing is realized through the foregoing processing.

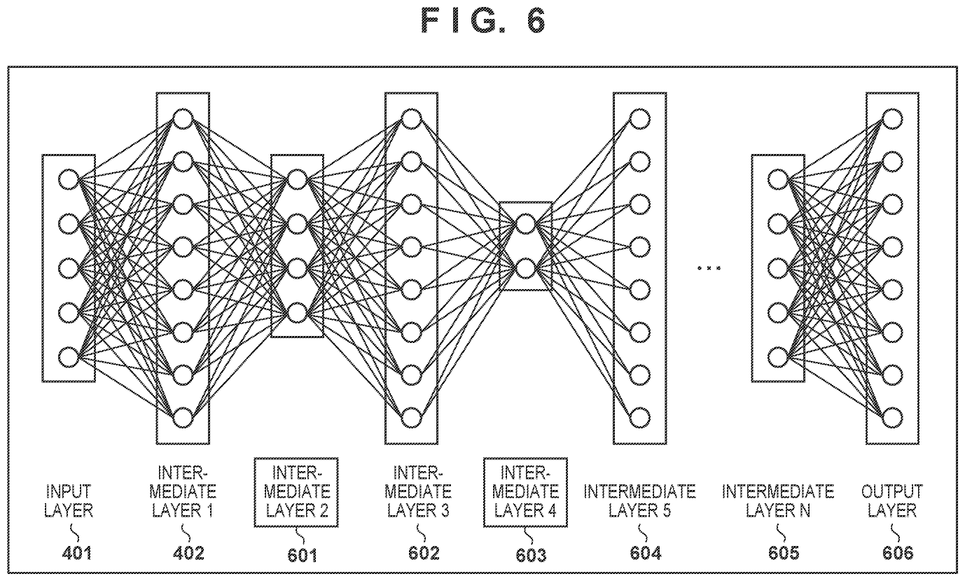

Note that the inference model according to the present embodiment is not limited to the configuration illustrated in FIG. 4, and may be configured as illustrated in FIG. 6, for example.

FIG. 6 is a conceptual diagram illustrating another example of a training phase according to the first embodiment. The present embodiment assumes that the training is performed in advance by a high-performance PC or the like. As illustrated in FIG. 6, the inference model is constituted by the input layer 401, the intermediate layer 1-402, an intermediate layer 2-601, an intermediate layer 3-602, an intermediate layer 4-603, an intermediate layer 5-604, an intermediate layer N-605, and an output layer 606. The input layer 401 and the intermediate layer 1-402 are the same as those illustrated in FIG. 4. The intermediate layer 3-602 to intermediate layer N-605 and the output layer 606 constitute an inference device having completely different nodes and parameters from those of the intermediate layer 3-405 to the intermediate layer N-406 and the output layer 407 indicated in FIG. 4. As illustrated in FIG. 6, the configuration is different from FIG. 4 in that a plurality of low-node intermediate layers (the intermediate layer 2-601 and the intermediate layer 4-603, in the example of FIG. 6) are prepared during training. Performing the training in this manner makes it possible to change, as desired, which low-node intermediate layer the sharing of the inference processing between the image capturing apparatus 101 and the server 103 is based on in the inference phase.

For example, the low-node intermediate layer used in the sharing can be switched in accordance with the communication conditions of the communication network 102. When the communication network 102 is capable of high-speed communication (when the communication speed is greater than or equal to a first threshold), the CPU 212 of the image capturing apparatus 101 performs the processing up to the intermediate layer 2-601 and requests the server 103 to perform the remaining processing. On the other hand, when the communication network 102 is capable only of low-speed communication (when the communication speed is less than the first threshold), the CPU 212 of the image capturing apparatus 101 performs the processing up to the intermediate layer 4-603 and requests the server 103 to perform the remaining processing. Making it possible to change the low-node intermediate layer used in the sharing as desired in this manner makes it possible to structure the inference system so as to complete the inference in the shortest time possible, taking into account the communication state of the communication network 102 as well.

As another example, the low-node intermediate layer used in the sharing may be switched in accordance with the remaining battery power of the image capturing apparatus 101. When the remaining battery power of the image capturing apparatus 101 is low (when the remaining battery power is less than a second threshold), the CPU 212 of the image capturing apparatus 101 performs the processing up to the intermediate layer 2-601, and requests the server 103 to perform the remaining processing. On the other hand, when the remaining battery power of the image capturing apparatus 101 is sufficient (when the remaining battery power is greater than or equal to the second threshold), the CPU 212 of the image capturing apparatus 101 performs the processing up to the intermediate layer 4-603, and requests the server 103 to perform the remaining processing. In this manner, the inference processing may be switched having ranked the relative priorities of time required for operations and power consumption of the image capturing apparatus 101.

Here, the intermediate layer 2-601 (a first intermediate layer) is an intermediate layer having a lower number of nodes than the input layer 401. The intermediate layer 4-603 (a second intermediate layer) is an intermediate layer disposed after the intermediate layer 2-601 (the first intermediate layer) and having a lower number of nodes than the intermediate layer 2-601 (the first intermediate layer). For example, the intermediate layer 4-603 (the second intermediate layer) is the intermediate layer, of the plurality of intermediate layers included in the neural network, that has the lowest number of nodes, and the intermediate layer 2-601 (the first intermediate layer) is the intermediate layer having the next-lowest number of nodes after the intermediate layer 4-603 (the second intermediate layer).

Note also that the data structure of the output data from the low-node intermediate layer, received by the server 103, will differ depending on whether the image capturing apparatus 101 sends the output data from the intermediate layer 2-601 or the output data from the intermediate layer 4-603 to the server 103. As such, the server 103 can identify whether the low-node intermediate layer (the specific intermediate layer) corresponding to the output data is the intermediate layer 2-601 or the intermediate layer 4-603 on the basis of the data structure.

As described thus far, according to the first embodiment, the image capturing apparatus 101 performs the computational processing of the part of the neural network from the input layer 401 to the low-node intermediate layer (the intermediate layer 2-403) (the first part) for the input data input to the input layer 401. The image capturing apparatus 101 then sends the output data from the low-node intermediate layer to an external inference apparatus (the server 103). The server 103 then obtains an inference result by performing the computational processing of the remaining part of the neural network, excluding the first part (the second part) on the output data from the low-node intermediate layer. The server 103 then sends the inference result to the image capturing apparatus 101.

In this manner, according to the first embodiment, the intermediate layer corresponding to the output data sent from the image capturing apparatus 101 to the server 103 is the low-node intermediate layer (a specific intermediate layer having a lower number of nodes than the input layer). Thus according to the present embodiment, the inference processing can be shared between two inference apparatuses so as to shorten the amount of time required for communication between the two inference apparatuses.

### Second Embodiment

A second embodiment will describe processing performed when the communication network 102 used for the communication between the image capturing apparatus 101 and the server 103 is cut off (e.g., when the communication network 102 is a wireless network and the signal state is poor). In the present embodiment, the basic configurations of the inference system 100, the image capturing apparatus 101, and the server 103 are the same as in the first embodiment (see FIGS. 1 and 2). The following will primarily describe areas that are different from the first embodiment.

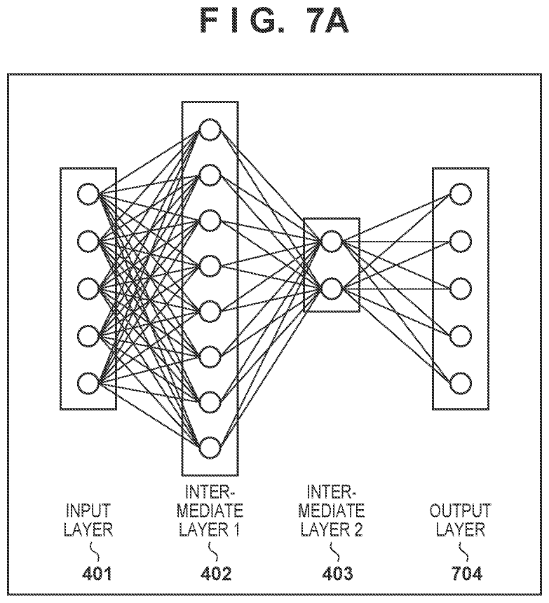

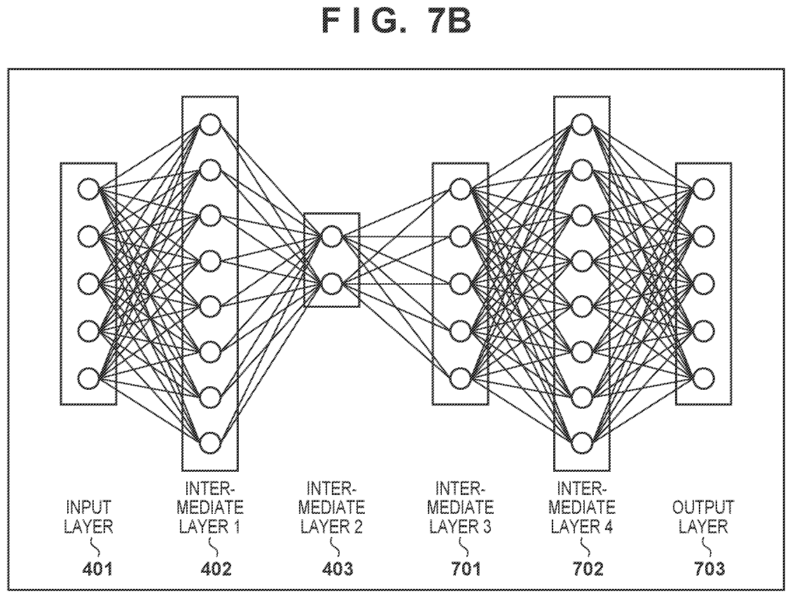

FIG. 7A is a conceptual diagram illustrating a training phase according to the second embodiment. The present embodiment assumes that the training is performed in advance by a high-performance PC or the like. The parameters of the input layer 401, the intermediate layer 1-402, and the intermediate layer 2-403 have the same configurations as the parameters trained as illustrated in FIG. 4. In other words, in the present embodiment, first, training is performed using the configuration illustrated in FIG. 7A, and the parameters of the input layer 401, the intermediate layer 1-402, and the intermediate layer 2-403 are created. Next, the training of the intermediate layer 3-405 to the output layer 407 is performed in a state where the parameters of the input layer 401, the intermediate layer 1-402, and the intermediate layer 2-403 indicated in FIG. 4 are frozen. Although the present embodiment describes the number of layers in FIG. 7A as being two, the number is not limited thereto. A training phase in which more intermediate layers are set will be described later with reference to FIG. 7B.

In the operations of a neural network trained in this manner, the input layer 401, the intermediate layer 1-402, and the intermediate layer 2-403 can be the same for both FIG. 4 (a first neural network) and FIG. 7A (a second neural network). The part from the input layer 401 to the intermediate layer 2-403 has the same trained parameters in FIG. 4 (the first neural network) and in FIG. 7A (the second neural network). As such, in FIG. 4, an inference system using an N-layer neural network including the intermediate layer 1-402 to the intermediate layer N-406 can be prepared, and in FIG. 7A, an inference system using a two-layer neural network including an intermediate layer 1-401 and an intermediate layer 2-402 can be prepared. In this manner, in an inference system including two neural networks, the neural networks are trained in advance to produce similar recognition results. The inference system using the neural network illustrated in FIG. 4 has a higher inference accuracy than the inference system using the neural network illustrated in FIG. 7A.

FIG. 7B is a conceptual diagram illustrating another example of a training phase according to the second embodiment. The present embodiment assumes that the training is performed in advance by a high-performance PC or the like. In the configuration illustrated in FIG. 7B, the parameters of the input layer 401, the intermediate layer 1-402, and the intermediate layer 2-403 have the same configurations as the parameters trained as illustrated in FIG. 4. Training is performed for an intermediate layer 3-701 to an output layer 703. In other words, the training is performed only for the intermediate layer 3-701 to the output layer 703, and the parameters for the input layer 401 to the intermediate layer 2-403 are frozen to the parameters trained as indicated in FIG. 4, and used. Although the present embodiment describes the number of intermediate layers in FIG. 7B as being four, the number is not limited thereto, and any desired number of layers lower than the number of layers in FIG. 4 may be set. However, it is necessary to set this number of layers and the number of nodes so that the operations of the neural network can be completed within an amount of time anticipated on the basis of the computational processing power of the image capturing apparatus 101.

In the operations of the neural network trained in this manner, the layers up to the input layer 401, the intermediate layer 1-402, and the intermediate layer 2-403 can be the same for both FIG. 4 and FIG. 7B. In terms of the order of the training, although an example in which the parameters of the input layer 401 to the intermediate layer 2-403 following the training indicated in FIG. 4 are used to train the intermediate layer 3-701 to the output layer 703 is described here, the training indicated in FIG. 7B may be performed first. Making the intermediate layer 1-402 and the intermediate layer 2-403, which are the results of the training, be the same is the essential point here.

As such, in FIG. 4, an inference system using an N-layer neural network including the intermediate layer 1-401 to the intermediate layer N-406 can be prepared, and in FIG. 7B, an inference system using a four-layer neural network including the intermediate layer 1-401 to an intermediate layer 4-702 can be prepared. The intermediate layer 3-405 in FIG. 7A and the intermediate layer 3-701 in FIG. 7B have completely different nodes and parameters. Additionally, the output layer 407 in FIG. 7A and the output layer 703 in FIG. 7B have completely different nodes and parameters.

In the following descriptions, an inference system using the neural network in FIG. 7A or FIG. 7B will be called an “inference system B”. Meanwhile, an inference system using the neural network in FIG. 4 will be called an “inference system A”. It is assumed that which of FIGS. 7A and 7B is used for the inference system B is determined in advance.

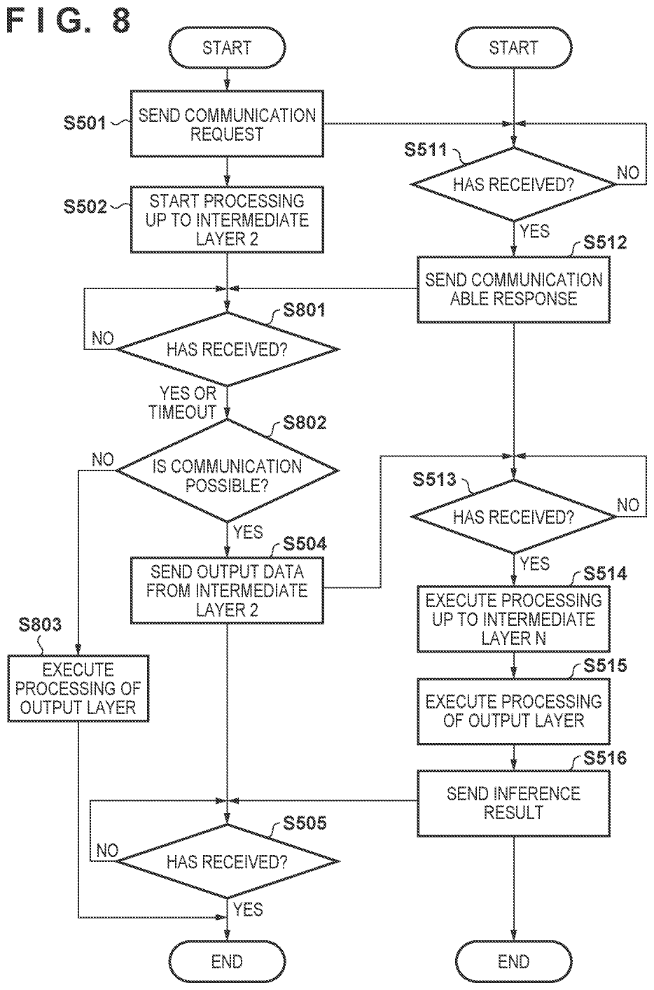

FIG. 8 is a flowchart illustrating inference processing according to the second embodiment. In FIG. 8, steps S501, S502, S504, S505, and S801 to S803 are processing steps executed by the image capturing apparatus 101, whereas steps S511 to S516 are processing steps executed by the server 103. The processing performed in steps S501, S502, S504, S505, and S511 to S516 is the same as in FIG. 4 (the first embodiment).

The processing of the image capturing apparatus 101, executed in steps S801 to S803, will be described here. In step S801, the CPU 212 of the image capturing apparatus 101 stands by to receive a communication able response from the server 103. When the CPU 212 of the image capturing apparatus 101 receives the communication able response, the sequence moves to step S802. If a predetermined amount of time passes and the CPU 212 of the image capturing apparatus 101 has still not received the communication able response (i.e., when a timeout has occurred), the sequence moves to step S802.

In step S802, the CPU 212 of the image capturing apparatus 101 determines whether or not communication with the server 103 is possible. If the communication able response has been received in step S801, the CPU 212 of the image capturing apparatus 101 determines that communication with the server 103 is possible, and the sequence moves to step S504. However, if a timeout has occurred in step S801, the CPU 212 of the image capturing apparatus 101 determines that communication with the server 103 is not possible, and the sequence moves to step S803.

In step S803, the CPU 212 of the image capturing apparatus 101 executes processing of the output layer 703 in FIG. 7A (or the intermediate layer 3-701 to the output layer 703 in FIG. 7B) (the computational processing of the second part of the second neural network). In this manner, when the image capturing apparatus 101 cannot communicate with the server 103, the inference processing is performed by the inference system B (i.e., the inference processing is not shared).

On the other hand, the processing from step S504 and on is the same as in the first embodiment, and thus if the image capturing apparatus 101 can communicate with the server 103, the inference processing is performed by the inference system A (FIG. 4).

As described thus far, according to the second embodiment, when the image capturing apparatus 101 cannot communicate with the server 103, the inference processing is not shared, and an inference result is obtained from the image capturing apparatus 101 only. In this case, the image capturing apparatus 101 uses a neural network with a lower number of intermediate layers than the neural network used when communication with the server 103 is possible. These two neural networks have the same node configurations and same trained parameters with respect to the parts from the input layer to the low-node intermediate layer (the first part). Thus according to the second embodiment, even if communication with the server 103 is not possible, the image capturing apparatus 101 can obtain an inference result on its own while effectively using the results of computations up to the low-node intermediate layer.

Note that the condition under which the image capturing apparatus 101 does not share the inference processing is not limited to a state in which communication with the server 103 is not possible. To put this more generally, the image capturing apparatus 101 does not share the inference processing when a predetermined condition is met.

Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-016491, filed Feb. 3, 2020 which is hereby incorporated by reference herein in its entirety.

What is claimed is:

1. An inference apparatus that shares inference processing with an external inference apparatus, the inference processing using a first neural network having an input layer, a plurality of intermediate layers, and an output layer, and the inference apparatus comprising:
a control unit configured to perform control for performing computational processing of a first part of the first neural network with respect to input data input to the input layer, the first part of the first neural network being a part from the input layer to a specific intermediate layer that, of the plurality of intermediate layers, has a lower number of nodes than the input layer;
a sending unit configured to send output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and
a receiving unit configured to receive the first inference result from the external inference apparatus.

2. The inference apparatus according to claim 1,
wherein the specific intermediate layer is an intermediate layer, among the plurality of intermediate layers, having a lowest number of nodes.

3. The inference apparatus according to claim 1,
wherein the plurality of intermediate layers include a first intermediate layer having a lower number of nodes than the input layer, and a second intermediate layer disposed after the first intermediate layer and having a lower number of nodes than the first intermediate layer, and
the control unit performs control for using the first intermediate layer or the second intermediate layer as the specific intermediate layer.

4. The inference apparatus according to claim 3,
wherein the second intermediate layer is an intermediate layer, among the plurality of intermediate layers, having a lowest number of nodes, and
the first intermediate layer is an intermediate layer, among the plurality of intermediate layers, having a lowest number of nodes except for the second intermediate layer.

5. The inference apparatus according to claim 3,
wherein the control unit performs control so that the first intermediate layer is used as the specific intermediate layer when a communication speed with the external inference apparatus is greater than or equal to a first threshold, and the second intermediate layer is used as the specific intermediate layer when the communication speed is less than the first threshold.

6. The inference apparatus according to claim 3,
wherein the control unit performs control so that the first intermediate layer is used as the specific intermediate layer when a remaining battery power of the inference apparatus is less than a second threshold, and the second intermediate layer is used as the specific intermediate layer when the remaining battery power is greater than or equal to the second threshold.

7. The inference apparatus according to claim 1,
wherein when a predetermined condition is met, the control unit performs control to obtain a second inference result by performing computational processing of a second part of a second neural network with respect to the output data from the specific intermediate layer, the second neural network being constituted by a first part including an input layer and the second part including an output layer,
a number of intermediate layers in the second neural network is lower than a number of intermediate layers in the first neural network,
the first part of the second neural network is the same as the first part of the first neural network, and
the first part of the first neural network and the first part of the second neural network have same trained parameters.

8. The inference apparatus according to claim 7,
wherein the predetermined condition is met when communication with the external inference apparatus is not possible.

9. An inference apparatus that shares inference processing with an external inference apparatus, the inference processing using a first neural network having an input layer, a plurality of intermediate layers, and an output layer, and the inference apparatus comprising:
a receiving unit configured to receive, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer;
a control unit configured to perform control for obtaining a first inference result by performing computational processing of a second part of the first neural network with respect to the output data from the specific intermediate layer, the second part of the first neural network being a remaining part excluding the first part from the first neural network; and
a sending unit configured to send the first inference result to the external inference apparatus.

10. The inference apparatus according to claim 9,
wherein the specific intermediate layer is an intermediate layer, among the plurality of intermediate layers, having a lowest number of nodes.

11. The inference apparatus according to claim 9,
wherein the plurality of intermediate layers include a first intermediate layer having a lower number of nodes than the input layer, and a second intermediate layer disposed after the first intermediate layer and having a lower number of nodes than the first intermediate layer,
the external inference apparatus is configured to use the first intermediate layer or the second intermediate layer as the specific intermediate layer, and
the control unit identifies which of the first intermediate layer and the second intermediate layer is being used as the specific intermediate layer on the basis of a data structure of the output data from the specific intermediate layer received from the external inference apparatus.

12. The inference apparatus according to claim 11,
wherein the second intermediate layer is an intermediate layer, among the plurality of intermediate layers, having a lowest number of nodes, and
the first intermediate layer is an intermediate layer, among the plurality of intermediate layers, having a lowest number of nodes except for the second intermediate layer.

13. An inference method, executed by an inference apparatus, for sharing inference processing with an external inference apparatus, the inference processing using a first neural network having an input layer, a plurality of intermediate layers, and an output layer, and the inference method comprising:
performing control for performing computational processing of a first part of the first neural network with respect to input data input to the input layer, the first part of the first neural network being a part from the input layer to a specific intermediate layer that, of the plurality of intermediate layers, has a lower number of nodes than the input layer;
sending output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and
receiving the first inference result from the external inference apparatus.

14. An inference method, executed by an inference apparatus, for sharing inference processing with an external inference apparatus, the inference processing using a first neural network having an input layer, a plurality of intermediate layers, and an output layer, and the inference method comprising:
receiving, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer;
performing control for obtaining a first inference result by performing computational processing of a second part of the first neural network with respect to the output data from the specific intermediate layer, the second part of the first neural network being a remaining part excluding the first part from the first neural network; and
sending the first inference result to the external inference apparatus.

15. A non-transitory computer-readable storage medium which stores a program for causing a computer to execute an inference method for sharing inference processing with an external inference apparatus, the inference processing using a first neural network having an input layer, a plurality of intermediate layers, and an output layer, and the inference method comprising:
performing control for performing computational processing of a first part of the first neural network with respect to input data input to the input layer, the first part of the first neural network being a part from the input layer to a specific intermediate layer that, of the plurality of intermediate layers, has a lower number of nodes than the input layer;
sending output data from the specific intermediate layer to the external inference apparatus, the external inference apparatus being configured to obtain a first inference result by performing computational processing of a second part of the first neural network with respect to the output data from the specific intermediate layer, and the second part of the first neural network being a remaining part excluding the first part from the first neural network; and
receiving the first inference result from the external inference apparatus.

16. A non-transitory computer-readable storage medium which stores a program for causing a computer to execute an inference method for sharing inference processing with an external inference apparatus, the inference processing using a first neural network having an input layer, a plurality of intermediate layers, and an output layer, and the inference method comprising:
receiving, from the external inference apparatus, output data from a specific intermediate layer having a lower number of nodes than the input layer, the output data being obtained by performing, with respect to input data input to the input layer, computational processing of a first part of the first neural network including the specific intermediate layer, and the first part of the first neural network being a part from the input layer to the specific intermediate layer;
performing control for obtaining a first inference result by performing computational processing of a second part of the first neural network with respect to the output data from the specific intermediate layer, the second part of the first neural network being a remaining part excluding the first part from the first neural network; and
sending the first inference result to the external inference apparatus.
